(19) United States
(12) Patent Application Publication
(10) Pub. No.: US 2013/0287255 A1
(43) Pub. Date: Oct. 31, 2013

(54) METHOD AND APPARATUS OF DETECTING REAL SIZE OF ORGAN OR LESION IN MEDICAL IMAGE

(71) Applicant: Kyungpook National University Industry-Academic Cooperation Foundation, (US)

(72) Inventors: Byeong-Cheol AHN, Daegu (KR); Gil-Hwan AHN, Daegu (KR)

(73) Assignee: KYUNGPOOK NATIONAL UNIVERSITY INDUSTRY-ACADEMIC COOPERATION FOUNDATION, Daegu (KR)

(21) Appl. No.: 13/870,212

(22) Filed: Apr. 25, 2013

(30) Foreign Application Priority Data
Apr. 27, 2012 (KR) 10-2012-0044862

(51) Int. Cl. G06T 7/00

(52) U.S. Cl. CPC G06T 7/0012
USPC 382/103

(57) ABSTRACT

A method of detecting a real size of an object from a medical image is provided. The method includes: receiving depth information of the object which is a distance between the object and a skin of a patient; measuring a distance between the pinhole and the skin; detecting a magnified size of the object from the medical image; and calculating the real size of the object based on the depth information of the object, the distance between the pinhole and the skin, and the magnified size of the object, and the distance between the pinhole and the scintillator.

This application claims the priority of Korean Patent Application No. 10-2012-0044862, filed on Apr. 27, 2012 in the Korean Intellectual Property Office, the disclosure of which is incorporated herein in its entirety by reference.

### BACKGROUND OF THE INVENTION

1. Field of the Invention

The present invention relates to a medical imaging technique, and more particularly, to a method and apparatus for detecting a real size of an object such as an organ or lesion in a medical image including a magnified image of the organ or lesion by using a pinhole gamma camera imaging technique.

2. Description of the Related Art

Accurate diagnosis of an organ or lesion of a human body is crucial for selecting an effective medical treatment method and acquiring an optimal result of the treatment. For example, in the case of occurrence of a bone fracture or bruise, there is a medical imaging technique of injecting technetium-99m phosphate intravenously into a patient to gather around a lesion and sensing a gamma ray emitted from the lesion by using a pinhole gamma camera to make a diagnosis.

Like calcium, the technetium-99m phosphate selectively gathers around a calcified organ such as a bone in a human body. Since the technetium-99m phosphate has a very short half-life of 6 hours, the substance speedily disappears. Since the technetium-99m phosphate has very low energy of 140 KeV, the substance does not almost affect the human body. Therefore, the technetium-99m phosphate has been widely used in the world.

As the above-described medical imaging technique using the pinhole gamma camera, there is Korean Patent Application No. 10-2011-0028300 titled by “PINHOLE BONE SCAN GAMMA CORRECTION METHOD FOR ACCURATE DIAGNOSIS FOR OCCULT TRAUMATIC OSSEOUS LESIONS.”

The pinhole gamma camera is allowed to acquire a magnified image of a small-sized lesion or organ, so that the state of the organ or lesion can be accurately checked and diagnosed.

However, since the magnified image is acquired, there is a problem in that a real size of the organ or lesion cannot be measured.

In order to solve the problem, after a size indicator is placed on a surface of the organ or lesion, additional imaging is performed on the scale indicator, and the real size of the organ or lesion is estimated based on the imaged size indicator.

However, as described above, the process of placing the size indicator on the surface of the organ or lesion is very complicated and difficult. In addition, relatively many times of the imaging processes are required. Therefore, there is a problem in that much burden is imposed on a patient.

In addition, in the case where an organ or lesion occurs at a position where the size indicator cannot be placed, there is a problem in that the real size cannot be estimated.

Therefore, in the related art, development of a technique of estimating a real size of an organ or lesion without use of a size indicator has been acutely needed.

### SUMMARY OF THE INVENTION

The present invention is to provide a method and an apparatus for detecting a real size of an object such as an organ or lesion in a medical image including a magnified image of the organ or lesion by using a pinhole gamma camera imaging technique.

According to an aspect of the present invention, there is provided is a method of detecting a real size of an organ or lesion from a medical image, including: receiving depth information of the organ or lesion if detection of the real size of the organ or lesion which is magnified and imaged by a pinhole and a scintillator is requested; measuring a distance between the pinhole and a skin; detecting a magnified size of the organ or lesion in the medical image; and calculating the real size of the organ or lesion based on the depth information of the organ or lesion, the distance between the pinhole and the skin, and the magnified size of the organ or lesion, and the distance between the pinhole and the scintillator.

According to the present invention, it is possible to detect a real size of an object such as an organ or lesion in a medical image including a magnified image of the organ or lesion by using a pinhole gamma camera imaging technique without using a separate size indicator.

### BRIEF DESCRIPTION OF THE DRAWINGS

FIG. 1 is a diagram illustrating a concept of detecting a real size of an organ or lesion in a medical image according to a preferred embodiment of the present invention.

FIG. 2 is a diagram illustrating a confirmation of an apparatus for detecting a real size of an organ or lesion in a medical image according to a preferred embodiment of the present invention.

FIG. 3 is a flowchart illustrating a method of detecting a real size of an organ or lesion in a medical image according to a preferred embodiment of the present invention.

FIGS. 4 to 8 are diagrams illustrating an example of detecting a real size of an organ or lesion in a medical image according to a preferred embodiment of the present invention.

### DETAILED DESCRIPTION OF THE PREFERRED EMBODIMENTS

In the present invention, a real size of an organ or lesion is detected from a medical image obtained by a pinhole gamma camera imaging technique according to a basic characteristic of pinhole imaging.

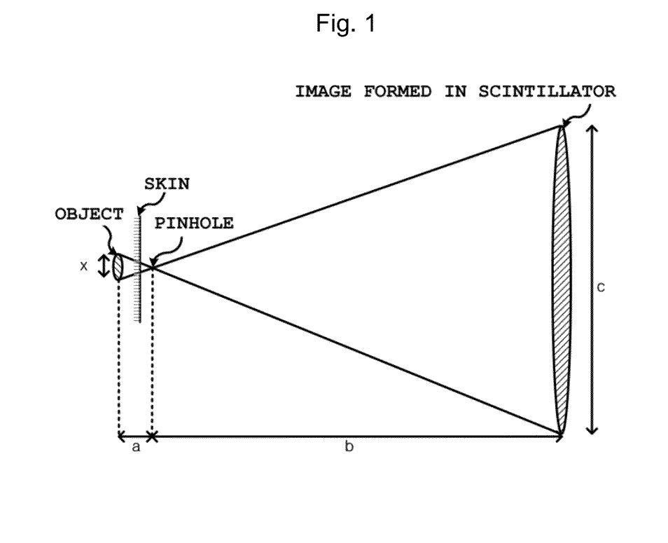

Now, a process of detecting the real size of the organ or lesion will be described with reference to FIG. 1 illustrating a concept of detecting the real size of the organ or lesion in a medical image according to a preferred embodiment of the present invention.

A pinhole gamma camera apparatus is configured to include a pinhole which magnifies and transmits a gamma ray emitting from a gamma ray emitting material which is injected into a human body and a scintillator which forms a medical image by sensing the gamma ray magnified and transmitted by the pinhole.

The pinhole is separated from a skin, and an object where the gamma ray emitting material is condensed exists under the skin.

The gamma ray emitted by the gamma ray emitting material condensed in the object is transmitted through the skin to the pinhole, and the pinhole magnifies the gamma ray which is emitted by the gamma ray emitting material condensed in the object such as the above-described organ or lesion and transmits the gamma ray to the scintillator.

The scintillator forms an image in response to the gamma ray.

The real size ‘x’ of the object varies with a distance ‘a’ between the pinhole and the object, a distance ‘b’ between the pinhole and the scintillator, and a size ‘c’ of the image formed in the scintillator as expressed by Equation 1.

x=(a×c)÷b [Equation 1]

As described above, although the real size ‘x’ of the object may be calculated from the distance ‘a’ between the pinhole and the object, the distance ‘b’ between the pinhole and the scintillator, and the size ‘c’ of the image formed in the scintillator, the skin of the human body is not flat, and the distance between the pinhole and the skin can be changed according to a manipulation manner or a patient's posture. In addition, the distance between the skin and the object can also be changed.

Therefore, according to the present invention, the distance between the pinhole and the skin and the distance between the skin and the object are detected by taking into consideration the characteristic of the pinhole gamma camera imaging technique, and the real size of the object is calculated based on the distance between the pinhole and the skin and the distance between the skin and the object.

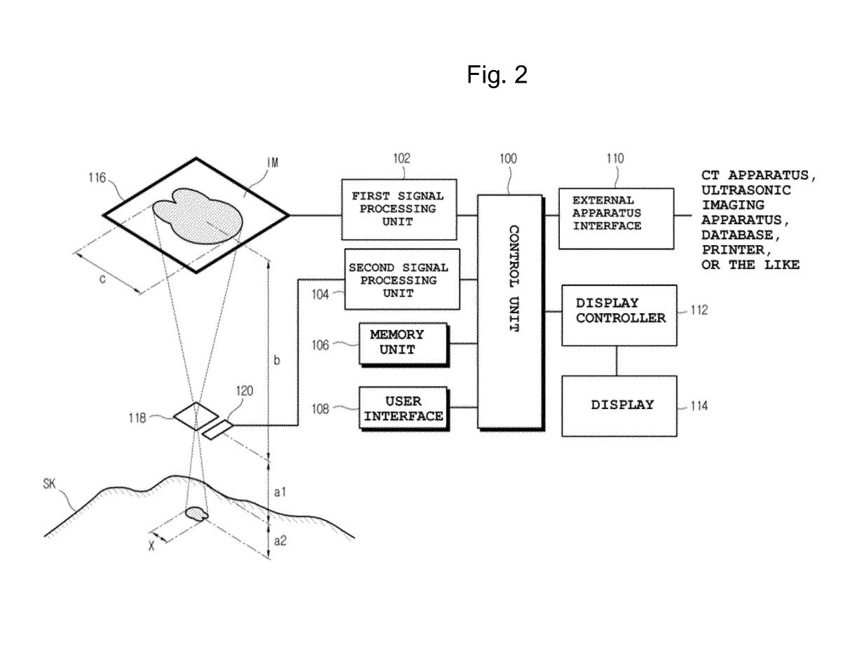

Now, a configuration of an apparatus for detecting a real size of an object, which is an organ or lesion, in a medical image according to a preferred embodiment of the present invention will be described in detail with reference to FIG. 2.

The apparatus for detecting the real size of the object in the medical image is configured to include a control unit 100, a first signal processing unit 102, a second signal processing unit 104, a memory unit 106, a user interface 108, an external apparatus interface 110, a display controller 112, and a display 114.

The control unit 100 performs a process of detecting the real size of the object in the medical image and outputs a result of the detection through the display controller 112 to the display 114 or transmits the result of the detection through the external apparatus interface 110 to an external apparatus.

The memory unit 106 stores various kinds of information including a processing program of the control unit 100. Particularly, the memory unit 106 stores a database including the depth information ‘a2’ of the object according to physical condition of a patient. The physical condition of a patient includes at least weight and height.

The user interface 108 receives various kinds of commands or information input by a user and transmits the commands or information to the control unit 100. The information input by the user may be information on the physical condition information of the patient, patient identification information, object identification information, and the like.

The external apparatus interface 110 is a unit for interfacing the external apparatus and the control unit 100. The external apparatus may be a CT (Computer tomography) apparatus, an ultrasonic imaging apparatus, a database, or the like which supplies depth information of an object of a patient, or may be a database which stores object information supplied from the control unit 100, a printer which prints the object information, or the like.

The display controller 112 allows the display 114 to display information according to the control of the control unit 100.

The display 114 displays various kinds of information according to the control of the control unit 100 through the display controller 112. The various kinds of information include information on the real size of the object of the patient.

The first signal processing unit 102 transmits imaging information obtained by using the scintillator 116 sensing the gamma ray to the control unit 100. The imaging information includes information IM on a magnified image of an object OB.

The second signal processing unit 104 transmits the distance measurement information, which is obtained from the distance measurement apparatus 120, to the control unit 100.

The distance measurement apparatus 120 is installed close to the pinhole 118 to measure a distance ‘a1’ between the installation position and the skin SK by using a laser or a ultrasonic wave and to transmit the distance measurement information through the second signal processing unit 104 to the control unit 100.

The pinhole 118 magnifies a gamma ray emitted from the object OB located under the skin SK and transmits the magnified gamma ray to the scintillator 116.

The scintillator 116 forms a medical image by using the imaging information acquired by sensing the gamma ray magnified and transmitted by the pinhole 118.

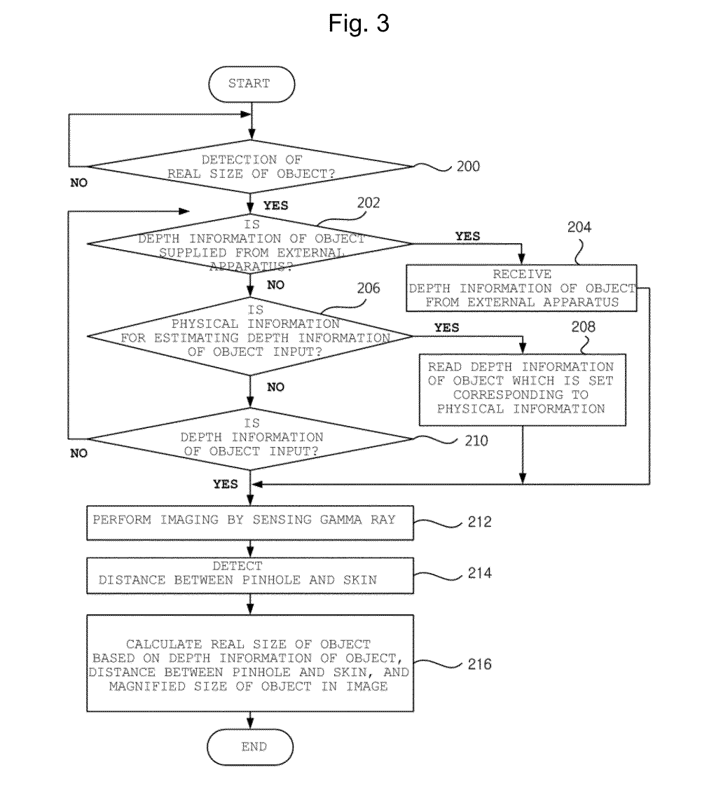

Now, a method of detecting a real size of an object, which is an organ or lesion, in a medical image according to a preferred embodiment of the present invention will be described in detail with reference to a flowchart illustrated in FIG. 3.

The control unit 100 checks whether or not detection of the real size of the object is requested through the user interface 108 (Step 200).

When the detection of the real size of the object is requested, the control unit 100 checks whether or not the user selects reception of depth information of the object from an external apparatus (Step 202).

When the user selects the reception of the depth information of the object from the external apparatus, the control unit 100 receives the depth information of the object corresponding to patient identification information and object identification information input by the user from the external apparatus selected by the user (Step 204). The external apparatus may be a database, a CT apparatus, or an ultrasonic imaging apparatus.

In addition, unlike the above-described case, the control unit 100 checks whether or not the user inputs physical information for estimating the depth information of the organ or lesion without selecting the depth information of the organ or lesion supplied from the external apparatus (Step 206).

When the user selects inputs the physical information for estimating the depth information of the object, the control unit 100 reads and obtains the depth information of the object, which is defined in advance so as to correspond to the physical information, from the memory unit 106 (Step 208). Herein, the physical information includes, for example, height, weight, obesity index, abdomen circumference, hip circumference, chest circumference, and the like. The depth information of the object corresponding to the physical information is configured as a table including depth information of the object according to physical information after the estimation thereof is performed in advance. The table is stored in the memory unit 106.

In addition, unlike the above-described case, the control unit 100 checks whether or not the user directly inputs the depth information of the object; and if the user directly inputs the depth information of the object, the control unit 100 stores the depth information of the object (Step 210).

After that, the control unit 100 performs imaging by using the scintillator 116 sensing the gamma ray (Step 212) and detects a distance ‘a1’ between the pinhole 118 and the skin SK by using the distance measurement apparatus 120 (Step 214).

As described above, if imaging information obtained by sensing the gamma ray is supplied, the control unit 100 detects the magnified size ‘c’ of the object in a medical image by sensing the gamma ray and calculates the real size ‘x’ of the object based on the distance ‘a1’ between the pinhole 118 and the skin SK and the depth information ‘a2’ as a distance between the skin SK to the object by using the scintillator 116 (Step 216). Herein, the real size of the object is calculated by Equation 2.

x=(a1+a2)×c÷b [Equation 2]

In Equation 2, x denotes the real size of the organ or lesion; a1 denotes the distance between the pinhole 118 and the skin SK; a2 denotes the depth which is the distance between the skin SK and the object OB; c denotes the magnified size of the object OB; and b denotes the distance between the scintillator 116 and the pinhole 118. The distance ‘b’ has a fixed value.

The magnified size of the object OB is input by the user, or the magnified size of the object OB is obtained by detecting a contour line of a portion sensitive to the gamma ray from the image.

Now, a result of the above-described detection of the real size according to the present invention will be described.

First, the distance between the pinhole and the scintillator is obtained. The actually-measured distance between the pinhole and the scintillator is in a range of 14.4 to 14.5 cm.

Next, a size indicator is manufactured. Herein, the size indicator is configured so that a radioactive material is indicated with a length of 5 cm.

Next, a pinhole image is obtained by photographing a thyroid by setting the distance between the pinhole and the skin to be in a range of 5 cm to 10 cm with an interval of 1 cm, and the distance between the two points of the size indicator is measured. It is determined whether not the real size thereof is detected.

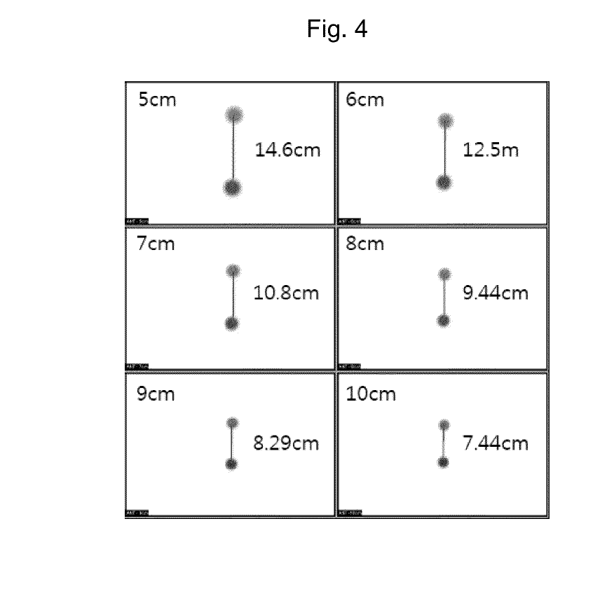

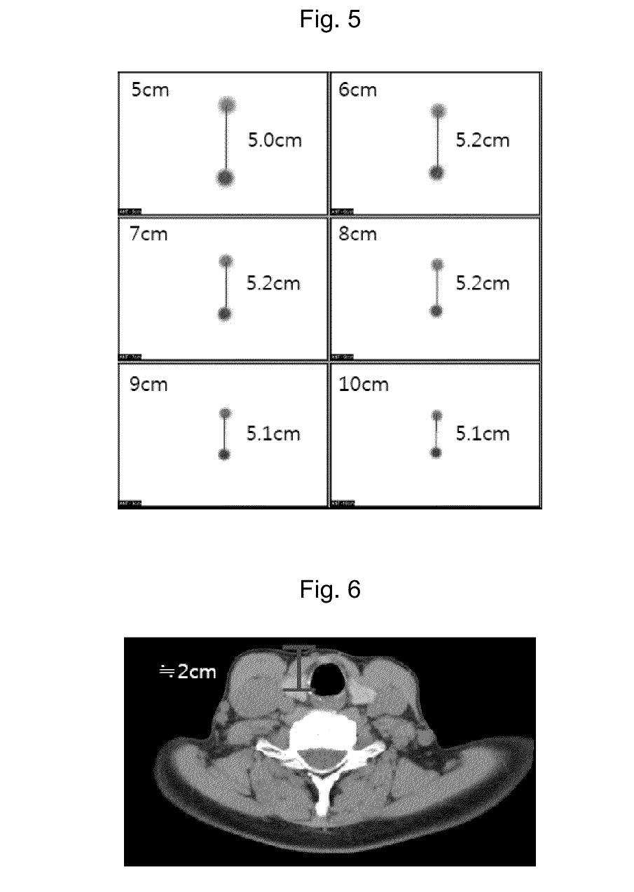

FIG. 4 illustrates images obtained by the pinhole gamma camera according to the above-described condition; and FIG. 5 illustrates real distances estimated according to the present invention. Referring to FIG. 4, in the image obtained by the pinhole gamma camera, the distance between the two points is in a range of 14.6 cm to 7.44 cm, and the image is magnified with respect to the real size of 5 cm. As a result of the detection according to the preferred embodiment, the real size detected from the magnified image is in a range of 5.0 cm to 5.2 cm, which is approximate to the real size of 5 cm.

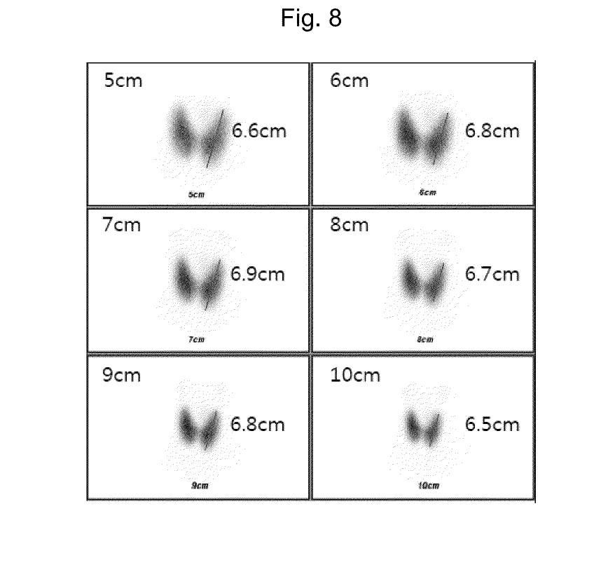

This process is applied to thyroid scanning, and the result is illustrated in FIGS. 6 to 8.

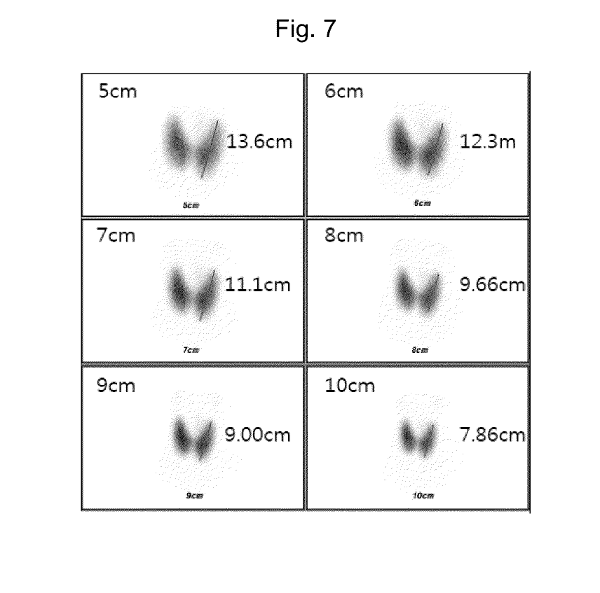

FIG. 6 illustrates a thyroid, and FIG. 7 illustrates an image obtained by the pinhole gamma camera. In the image obtained by the pinhole gamma camera, the thyroid is magnified so that the size thereof is in a range of 13.6 cm to 7.86 cm. As a result of the detection according to the preferred embodiment, the real size detected from the magnified image is in a range of 6.6 cm to 6.9 cm.

As described above, although the photographing is performed once in the preferred embodiment of the present invention, in order to improve accuracy of detection of the real size, the photographing is performed plural times while changing the distance between the pinhole and the skin with a pre-defined interval, a plurality of real sizes of the organ or lesion is detected based on information obtained from the plural times of photographing, and an average real size is obtained from the plurality of detected real sizes.

What is claimed is:

1. A method of detecting a real size of an object of a patient from a medical image which is magnified and imaged by a pinhole gamma camera system including a pinhole and a scintillator, comprising:
(a) receiving depth information of the object which is a distance between the object and a skin of the patient;
(b) measuring a distance between the pinhole and the skin;
(c) detecting a magnified size of the object in the medical image; and
(d) obtaining the real size of the object based on the depth information of the object, the distance between the pinhole and the skin, and the magnified size of the object in the medical image.

2. The method according to claim 1,
wherein in the step (d), the real size of the object is calculated by using the following equation, and
x=(a1+a2)×c÷b
wherein, in the above equation, x denotes a real size of the object, a1 denotes a distance between the pinhole and the skin, a2 denotes a depth that is a distance between the skin and the object, b denotes the distance between the scintillator and the pinhole, and c denotes the magnified size of the object.

3. The method according to claim 1, wherein the object is an organ or lesion.

4. The method according to claim 1, wherein in (a) the receiving of the depth information of the object, the depth information of the object is supplied from a database, which the database stores the depth information of the object corresponding to patient identification information and object identification information.

5. The method according to claim 1, wherein in (a) the receiving of the depth information of the object, the depth information of the object is supplied from a CT apparatus or input by a user.

6. The method according to claim 1, wherein in (a) the receiving of the depth information of the object, the depth information of the object is estimated depth information which is set corresponding to physical information, and the physical information includes weight and height of the patient.

7. The method according to claim 1, wherein in (c) the detecting of the magnified size of the object, the magnified size of the object in the medical image is input by a user or obtained by detecting a contour line of a portion sensitive to a gamma ray from the medical image.

8. An apparatus for detecting a real size of an object of a patient from a medical image, comprising:
a pinhole;
a scintillator which senses a gamma ray which is magnified and transmitted by the pinhole to generate a medical image;
a distance measurement unit which measures a distance between the pinhole and a skin of the patient; and
a control unit which receives depth information of an object corresponding to a distance between the skin and the object, measures the distance between the pinhole and the skin, detects a magnified size of the object in the medical image generated by the scintillator, and detects the real size of the object based on the depth information of the object, the distance between the pinhole and the skin, and the magnified size of the object in the medical image.

9. The apparatus according to claim 8,
wherein the control unit calculates the real size of the object by using the following equation, and
x=(a1+a2)×c÷b
wherein, in the above equation, x denotes a real size of the object, a1 denotes a distance between the pinhole and the skin, a2 denotes a distance between the skin and the object, b denotes a distance between the scintillator and the pinhole, and c denotes a magnified size of the object in the medical image.

10. The apparatus according to claim 8, further comprising an external apparatus interface which interfaces the control unit and an external apparatus,
wherein the control unit requests the external apparatus to supply the depth information of the object corresponding to patient identification information and object identification information through the external apparatus interface and receives the depth information of the object from the external apparatus.

11. The apparatus according to claim 8, further comprising a user interface which includes an input unit,
wherein the control unit is input patient identification information and object identification information through the user interface by a user and detects the depth information of the object corresponding to the patient identification information and the object identification information from a database or an external apparatus.

12. The apparatus according to claim 8, further comprising an external apparatus interface which interfaces the control unit and an external apparatus, wherein the control unit receives the depth information of the object through the external apparatus interface from an external apparatus including a CT apparatus or an ultrasonic imaging apparatus.

13. The apparatus according to claim 8, wherein the object is an organ or lesion.

14. The apparatus according to claim 8, wherein the control unit allow the magnified size of the object in the image generated by the scintillator to be input by a user or to be acquired by detecting a contour line of a portion sensitive to the gamma ray from the image.
